(19) United States
(12) Patent Application Publication
(10) Pub. No.: US 2011/0248951 A1
(43) Pub. Date: Oct. 13, 2011

(54) RESISTIVE TOUCH PANEL AND DISPLAY DEVICE USING THE SAME

(75) Inventor: SONG-LING YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (TW)

(21) Appl. No.: 12/875,091

(22) Filed: Sep. 2, 2010

(30) Foreign Application Priority Data
Apr. 9, 2010 (CN) 201010143536.0

(51) Int. Cl. G06F 3/045

(52) U.S. Cl. 345/174

(57) ABSTRACT

A display device includes a resistive touch panel, which includes a touch layer, a conductive layer, a resistance layer and an insulation layer, wherein the touch layer is the outermost layer of the touch panel, the insulation layer is arranged between the conductive layer and the resistance layer to separate the conductive layer and the resistance layer. The conductive layer is electrically connected to a voltage detector. The resistance layer includes a resistor, the resistor is oriented in a labyrinth-type pattern on the resistance layer and includes a first end and a second end, the first end and the second end are connected to a power source, and the first end further is connected to a current detector.

### BACKGROUND

1. Technical Field

The present disclosure relates to touch panels and, particularly, to a resistive touch panel and a display device using a resistive touch panel.

2. Description of Related Art

A typical 4-terminal wires resistive touch panel includes two resistance layers separated by an insulation layer. Display devices employing the touch panels can accurately identify a single touch, but cannot identify more than one touch simultaneously. Furthermore, a 4-terminal wires resistive touch panel needs a complex driving method and a complex driving circuit, which accordingly increases cost.

Therefore, what is needed is a resistive touch panel to overcome the shortcomings of the conventional resistive touch panels.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a resistive touch panel according to an exemplary embodiment, showing a conductive layer, an insulation layer, and a resistance layer of the resistive touch panel.

FIG. 2 is a schematic view of the conductive layer, the insulation layer, and the resistance layer of the touch panel of FIG. 1, showing a point is touched.

FIG. 3 is a schematic view of another resistance layer different from the resistance layer of FIG. 2.

FIG. 4 is a block diagram of a display device using the touch panel of FIG. 1 according to an exemplary embodiment.

FIG. 5 is another schematic view of the conductive layer, the insulation layer, and the resistance layer of the touch panel of FIG. 1, showing two points are simultaneously touched.

FIG. 6 is schematic view of the conductive layer, the insulation layer, and the resistance layer of the touch panel according to a second embodiment, showing two points are simultaneously touched.

FIG. 7 is a block diagram of a display device using the touch panel of FIG. 6 according to the second embodiment.

### DETAILED DESCRIPTION

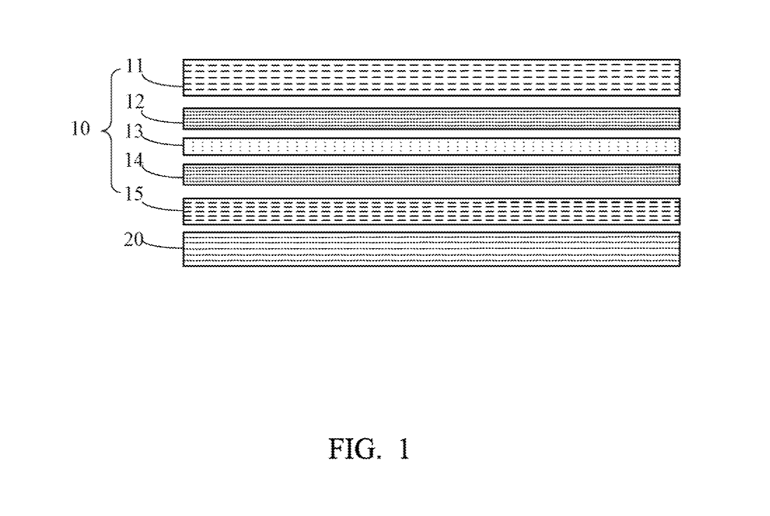

Referring to FIG. 1, an embodiment of a resistive touch panel 10 is illustrated. The touch panel 10 is attached to a display panel 20. The touch panel 10 from the top to the bottom includes a touch layer 11, a conductive layer 12, an insulation layer 13, a resistance layer 14, and a substrate 15. The touch layer 11 is made of elastic transparent insulated material and is the outermost layer of the touch panel 10. The substrate 15 is made of rigid transparent material and is attached to the display panel 20. The insulation layer 13 includes a plurality of flexible insulated grids, and is arranged between the conductive layer 12 and the resistance layer 14 to separate the conductive layer 12 from the resistance layer 14.

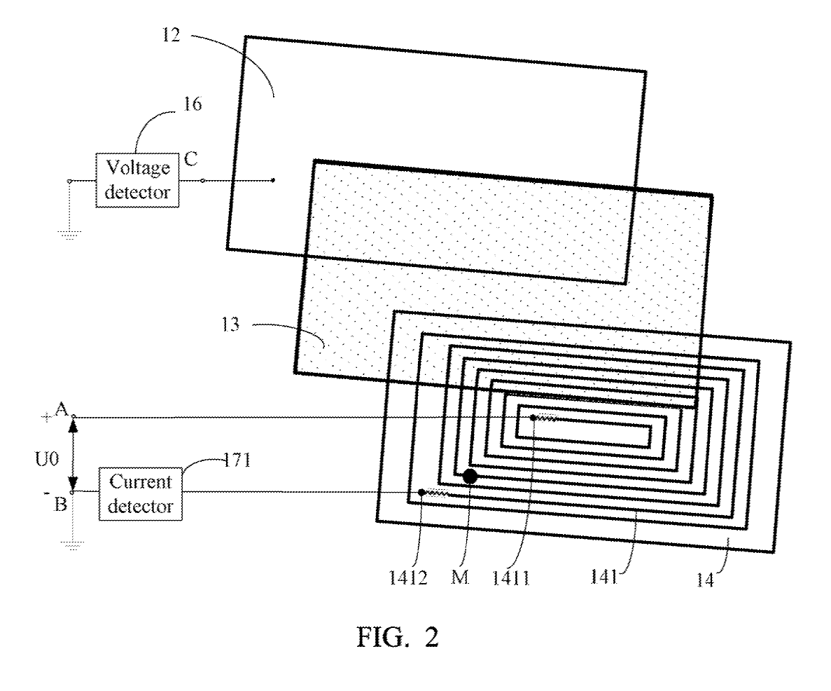

Referring to FIG. 2, the conductive layer 12 is a conductive metal layer, and is electrically connected to an external circuit (not shown) by a wire C. In the embodiment, the conductive layer 12 is electrically connected to a voltage detector 16 by the wire C. The voltage detector 16 is configured to detect the voltage value across the conductive layer 12. If no point is touched, the voltage detector 16 detects a zero voltage.

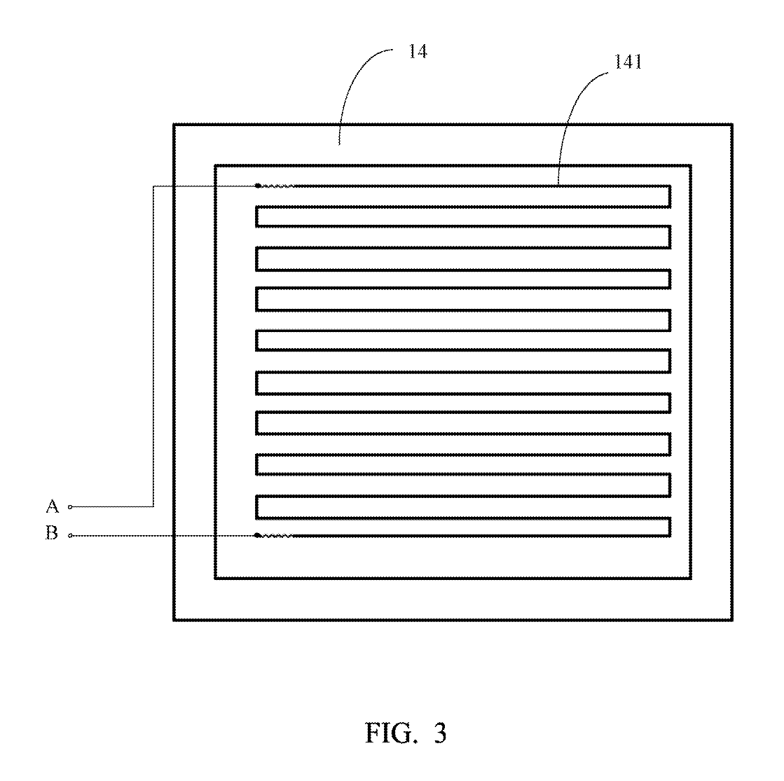

The resistance layer 14 includes a spiral labyrinth-type resistor 141 on a surface of the resistance layer 14. The resistance value of the resistor 141 is constant (hereinafter R0) and is far greater than that of the conductive layer 12. The resistor 141 includes two ends 1411 and 1412. A wire A is connected to the end 1411, and a wire B is connected to the end 1412. The resistance values of the wires A and B are far less than that of the resistor 141. In the embodiment, each of a plurality of points of the resistor 141 corresponds to a touchable point of the touch panel 10. In an alternative embodiment, the resistor 141 may follow a substantially back and forth labyrinth-type pattern (see FIG. 3).

The ends 1411 and 1412 are electrically connected to a power source (not labeled). The end 1411 is connected to an anode of the power source. The end 1412 is connected to a cathode of the power source by a current detector 171 and is also grounded by the current detector 171. In the embodiment, the voltage provided by the power source is |U0|. The current detector 171 is configured to detect the current flowing from the resistor 141 (hereinafter I0). For |U0| and R0 are constant, if no point of the resistor 141 is touched, I0 is equal to |U0|/R0 which is constant.

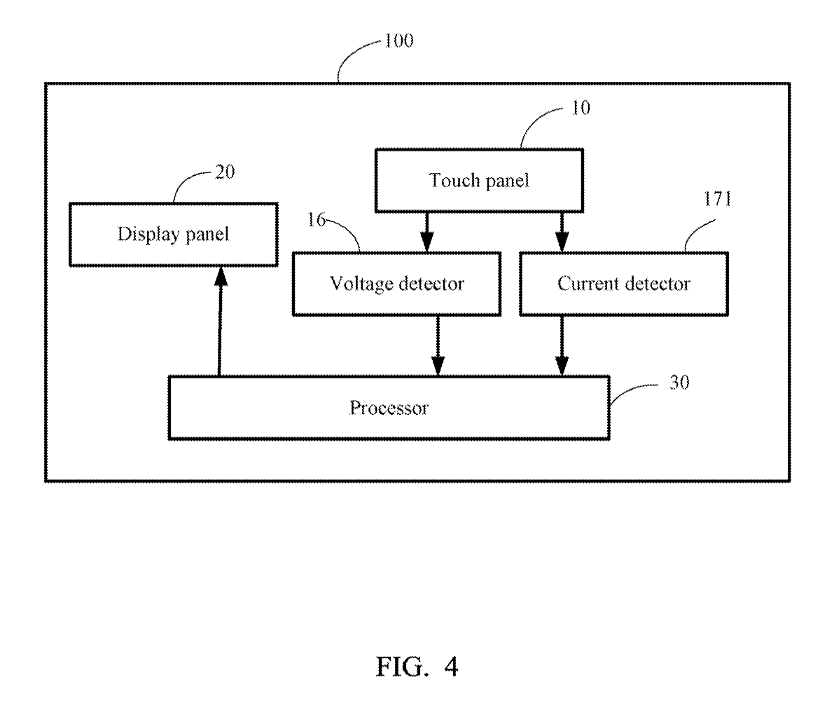

Referring also to FIG. 4, a first embodiment of a display device 100 is illustrated. The display device 100 includes the touch panel 10, the voltage detector 16, the current detector 171, the display panel 20, and a processor 30. The processor 30 is configured to identify which point of the resistor 141 is touched according to the voltage value detected by the voltage detector 16 and the current value detected by the current detector 171, and perform a function corresponding to one or more touched points. The display panel 20 is configured to display visual information.

In the embodiment, if a touchable point M is touched, the voltage value detected by the voltage detector 16 is changed to U1, and the current value detected by the current detector 171 is changed from I0 to I1. The voltage across the conductive layer 12 is equal to the voltage across the section from the point M to the end 1412.

As if only one touchable point is touched, the resistance value between the ends 1411 and 1412 is still R0, I1 is equal to I0. Therefore, the processor 30 identifies only one point is touched if I1 is equal to I0, and determines the resistance value R1 of the section from the point M to the end 1412 according to the formula |U0|/U1=R0/R1. The processor 30 then determines the length of the section from the point M to the end 1412 according to R1 and determines the coordinate value of the point M according to the length.

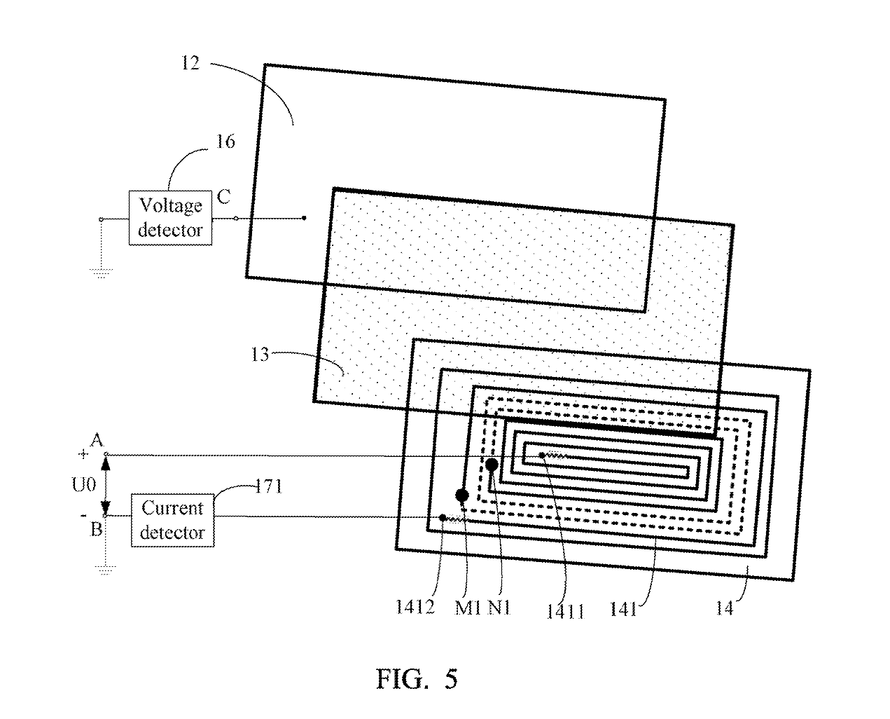

Referring to FIG. 5, if two touchable points M1 and N1 are simultaneously touched, the voltage value detected by the voltage detector 16 is changed to U2, and the current value detected by the current detector 171 is changed from I0 to I0. The voltage across the conductive layer 12 is equal to the voltage across the section from the point M1 to the end 1412, the voltage across the section from the point N1 to the end 1411 is equal to |U0|−U2, and the voltage across the section between the points M1 and N1 is zero.

As the voltage value of the section from the points M1 to N1 is zero, the resistance value of the section equals to zero, thus I2 is greater than I0. Therefore, the processor 30 identifies that two points are simultaneously touched if 12 is greater than I0, and determines the resistance value R2 of the section from the point M1 to the end 1412 according to the formula R2=U2/I2, and determines the resistance value R3 of the section from the point N1 to the end 1411 according to the formula |U0|/I2=R2+R3. The processor 30 then determines the length of the section from the point M1 to the end 1412 according to R2 and determines the coordinate value of the point M1 according to the length of the section from the point M1 to the end 1412, and determines the length of the section from the point N1 to the end 1411 according to R3 and determines the coordinate value of the point N1 according to the length of the section from the point N1 to the end 1411.

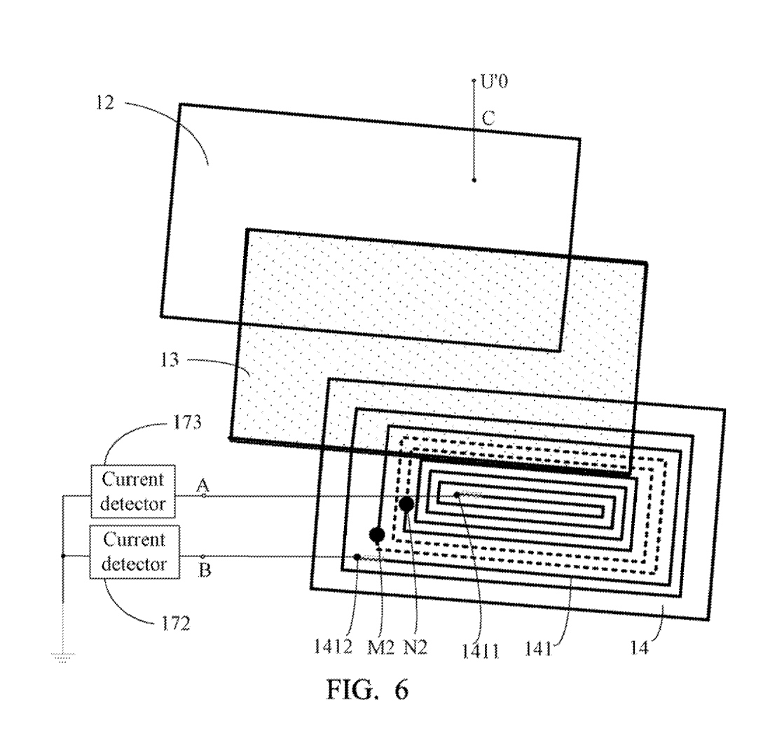

Referring to FIG. 6, a touch panel showing the conductive layer, the insulation layer and the resistance layer in a second embodiment is illustrated. The conductive layer 12 is connected to a power source (not labeled) by a wire C. In the embodiment, the voltage value provided by the power source is |U0′|. The end 1412 is connected to a current detector 172 and is also grounded by the current detector 172, the end 1411 is connected to a current detector 173 and is also grounded by the current detector 173. The current detectors 172, 173 are configured to detect the current of flowing from the end 1412 and the end 1411 correspondingly. If no point is touched, the current detectors 172, 173 detect a zero current.

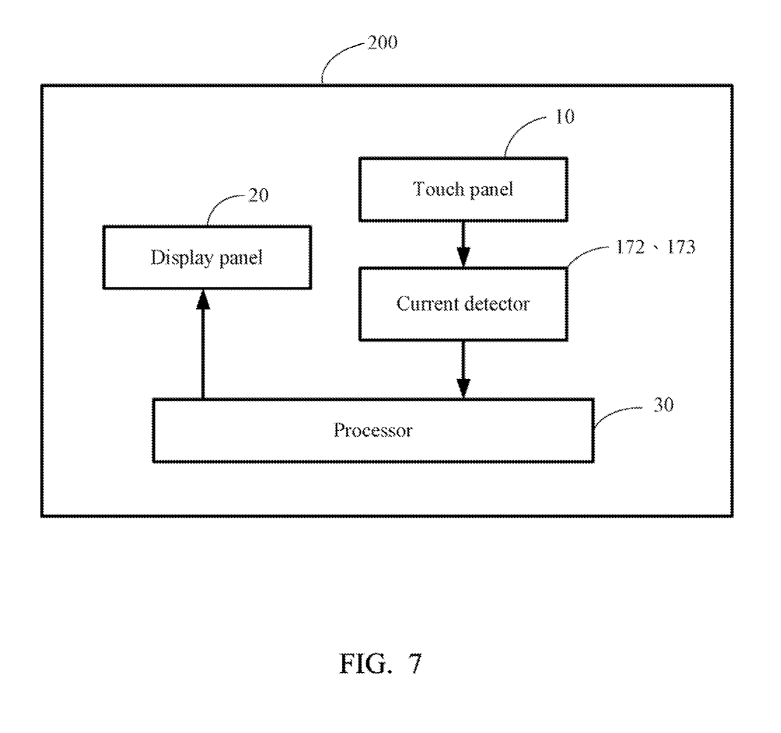

Referring to FIG. 7, a second embodiment of a display device 200 is illustrated. The display device 200 includes a touch panel 10, two current detectors 172 and 173, a display panel 20, and a processor 30. The processor 30 is configured to identify which point of the resistor 141 is touched according to the current values detected by the current detectors 172 and 173, and perform a function corresponding to one or more touched points. The display panel 20 is configured to display visual information.

In the embodiment, if only one point M2 is touched or two points M2 and N2 are simultaneously touched, the voltage value of the section of the resistor 14 from the point M2 to the end 1412 and the voltage value of another section of the resistor 14 from the point N2 to the end 1411 are both equal to the voltage across the conductive layer 12, the current value detected by the current detector 172 is changed to I2′, and the current value detected by the current detector 173 is changed to I3′.

Therefore, the processor 30 determines the resistance value R2′ of the section from the point M2 to the end 1412 according to the formula R2′=|U0′|/I2′, and determines the resistance value R3′ of the section from the point N2 to the end 1411 according to the formula R3′=|U0′|/I3′. The processor 30 then determines the length of the section from the point M2 to the end 1412 according to R2′ and determines the coordinate value of the point M2 according to the length of the section from the point M2 to the end 1412, and determines the length of the section from the point N2 to the end 1411 according to R3′ and determines the coordinate value of the point N2 according to the length of the section from the point N2 to the end 1411.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A resistive touch panel, comprising:
a touch layer being the outermost layer of the touch panel;
a conductive layer electrically connected to a voltage detector;
a resistance layer comprising a resistor, the resistor being oriented in a labyrinth-type pattern on the resistance layer and comprising a first end and a second end, the first end and the second end being connected to a power source, and the first end further being connected to a current detector; and
an insulation layer arranged between the conductive layer and the resistance layer to separate the conductive layer and the resistance layer.

2. The resistive touch panel of claim 1, wherein the resistor follows a spiral labyrinth-type pattern, and each of a plurality of points of the resistor corresponds to a touchable point of the touch panel.

3. The resistive touch panel of claim 1, wherein the resistor follows a substantially back and forth labyrinth-type pattern.

4. The resistive touch panel of claim 1, wherein the insulation layer comprises a plurality of flexible insulated grids.

5. A resistive touch panel comprising:
a touch layer being the outermost layer of the touch panel;
a conductive layer electrically connected to a power source;
a resistance layer comprising a resistor, the resistor being oriented in a labyrinth-type pattern on the resistance layer and comprising a first end and a second end, the first end being connected to a first current detector, the second end being connected to a second current detector; and
an insulation layer arranged between the conductive layer and the resistance layer to separate the conductive layer and the resistance layer.

6. The resistive touch panel of claim 7, wherein the resistor follows a spiral labyrinth-type pattern, and each of a plurality of points of the resistor corresponds to a touchable point of the touch panel.

7. The resistive touch panel of claim 7, wherein the resistor follows a substantially back and forth labyrinth-type pattern.

8. The resistive touch panel of claim 7, wherein the insulation layer comprises a plurality of flexible insulated grids.

9. A display device comprising:
a resistive touch panel comprising:
a touch layer being the outermost layer of the touch panel;
a conductive layer;
a resistance layer comprising a resistor, the resistor being oriented in a labyrinth-type pattern on the resistance layer and comprising a first end and a second end; and
an insulation layer arranged between the conductive layer and the resistance layer to separate the conductive layer and the resistance layer; and
a first current detector connected to the first end of the resistor;
a processor configured to determine the location of the touched points when the touch panel is touched, and perform a function corresponding to the touched points; and
a display panel configured to display visual information.

10. The display device of claim 9, further comprising a voltage detector connected to the conductive layer.

11. The display device of claim 10, wherein the first end and the second end are connected to a power source.

12. The display device of claim 11, wherein the processor identifies which point of the resistor is touched according to a voltage value detected by the voltage detector and a current value detected by the first current detector.

13. The display device of claim 9, further comprising a second current detector connected to the second end of the resistor.

14. The display device of claim 13, wherein the conductive layer is electrically connected to a power source.

15. The display device of claim 14, wherein the processor identifies which point of the resistor is touched according to a first current value detected by the first current detector and a second current value detected by the second current detector.
